(19) United States
(12) Patent Application Publication
(10) Pub. No.: US 2026/0143028 A1
(43) Pub. Date: May 21, 2026

(54) SYSTEMS AND METHODS OF PROCESSING DOMAIN LIMITED INFORMATION FOR CROSS-PLATFORM DATA MIGRATION

(71) Applicant: MINDFORTRESS HOLDINGS, LLC, Nashville, TN (US)

(72) Inventors: Christopher T. Nebel, Nashville, TN (US); Gerald Douglas Ruby, Vancouver, WA (US)

(21) Appl. No.: 19/389,138

(22) Filed: Nov. 14, 2025

Related U.S. Application Data
(60) Provisional application No. 63/721,857, filed on Nov. 18, 2024.

(51) Int. Cl. H04L 67/1095; G06F 11/32; G06F 16/3329; G06F 18/21; G06F 40/205; G06N 3/0475

(52) U.S. Cl. CPC H04L 67/1095; G06F 11/328; G06F 16/33295; G06F 18/217; G06F 40/205; G06N 3/0475

(57) ABSTRACT

Disclosed herein is a method for processing domain limited information for cross-platform data migration, comprising receiving user input on a secondary computing system, said user input being associated with a first platform, processing the user input via the secondary computing system and a central computing system, transmitting a gather request for data associated with one or more required conditions via the secondary computing system, receiving data via the secondary computing system in response to the gather request, determining whether the one or more required conditions are met, and performing a workflow when the one or more required conditions are met, said workflow associated with a second platform distinct from the first platform.

A portion of the disclosure of this patent document contains material that is subject to copyright protection. The copyright owner has no objection to the reproduction of the patent document or the patent disclosure, as it appears in the U.S. Patent and Trademark Office (USPTO) patent file or records, but otherwise reserves all copyright rights whatsoever.

### CROSS-REFERENCE TO RELATED APPLICATIONS

The present application claims priority to, and benefit from, a U.S. provisional patent application filed on Nov. 18, 2024, identified as U.S. Appl. No. 63/721,857, and which is incorporated by reference in its entirety.

### FIELD OF THE DISCLOSURE

The present disclosure relates to systems and methods for processing domain limited information, and more particularly to systems and methods for processing domain limited user input utilizing artificial intelligence for the migration of data across heterogenous platforms.

### BACKGROUND

For various reasons, many businesses and individuals alike are switching from a traditional telephony system to cloud-based voice communication systems. Traditional telephony systems connect one or more telephone devices to a public phone network via a public switched telephone network (PSTN) or integrated services digital network (ISDN) line. Cloud-based voice communication systems, on the other hand, use a remotely hosted system that does not have the geographic boundaries associated with traditional telephony systems. These cloud-based voice communication systems typically rely on Voice over Internet Protocol (VOIP) technology to transmit data, including voice communications, to users on internet-connected devices. Thus, cloud-based voice communication systems are typically considered to have better flexibility, features, mobility, and cost-effectiveness as compared to traditional telephony systems. However, current cloud-based voice communication systems are not without their limitations.

Certain cloud-based voice communication systems, such as Zoom, Slack, Skype, Google Meet, WebEx, and Microsoft Teams to name a few examples, are unable to accurately abstract user requests. These systems often include a graphic user interface (GUI) and an application programming interface (API). The GUI may be a software platform configured to visually present data to users of electronic devices in a way that is easily understandable to the user such that the user may interact with an application or system. The electronic devices may be configured to receive user input, for example, via a user interacting with the GUI using a user input device(s), such as a mouse, keyboard, touch-screen interface, and the like. The API may act as an intermediary that facilitates communication across multiple applications or systems. APIs typically include a set of rules, protocols, and/or tools for building or otherwise interacting with software. Notably, lay user are typically unable to configure or otherwise interact with APIs, and instead rely on interacting with an associated GUI.

When a user request is received via a user's interaction with the GUI, the cloud-based voice communication system must then process the user request and, through the API, map the request to the correct tool or predefined operation. Various inefficiencies and/or inaccuracies result from inconsistencies between the GUI, with which the user views the application and interacts therewith, and the API, which handles the back-end functions of the application. Thus, there is a need to provide apparatuses, methods, or systems that overcome the foregoing limitations.

### BRIEF SUMMARY

Embodiments of apparatuses, methods, and systems of the present disclosure provide a solution to the shortcomings above.

The present disclosure provides an embodiment of a method for processing domain limited information for cross-platform data migration. The method may comprise receiving user input on a secondary computing system, said user input being associated with a first platform, and processing the user input via the secondary computing system and a central computing system. Processing the user input may include transmitting data representative of the user input via the secondary computing system to the central computing system to determine a desired output, and selecting a workflow based at least in part on the desired output, the workflow being associated with one or more required conditions. The method may further include transmitting a gather request for data associated with the one or more required conditions via the secondary computing system, receiving data via the secondary computing system in response to the gather request, determining whether the one or more required conditions are met, and performing the workflow when the one or more required conditions are met, said workflow associated with a second platform distinct from the first platform.

In certain embodiments, processing the user input via the secondary computing system and central computing system may include processing the user input via an artificial intelligence (AI) system associated with the secondary computing system and the central computing system.

In certain embodiments, the AI system may be a domain-specific large language model.

In certain embodiments, the AI system may be continuously trained such that the accuracy of the AI system improves.

In certain embodiments, the method may include generating a graphic user interface for display on an electronic device, wherein the electronic device may be configured to receive the user input through the GUI.

In certain embodiments, the graphic user interface may correspond to the first platform.

In certain embodiments, transmitting data representative of the user input via the secondary computing system to the central computing system to determine a desired output may include identifying the one or more required conditions.

In certain embodiments, transmitting data representative of the user input via the secondary computing system to the central computing system to determine a desired output may include determining the desired output via an AI system.

In certain embodiments, determining the desired output via an AI system may include parsing the user input into structured parameters.

In certain embodiments, processing the user input via the secondary computing system and the central computing system may include receiving one or more steps associated with the workflow via the secondary computing system.

In certain embodiments, the method may include transmitting an additional data request to an electronic device associated with a user when at least one of the one or more required conditions are not met.

In certain embodiments, the method may include receiving additional user input via the secondary computing system in response to the additional data request.

In certain embodiments, performing the workflow when the one or more required conditions are met may include migrating data from the first platform to the second platform.

In certain embodiments, the method may include generating a representation of a final output on an electronic device associated with a user.

In certain embodiments, the method may include generating a status message associated with a final output on an electronic device associated with a user.

In certain embodiments, the central computing system and the secondary computing system may communicate via API calls.

In accordance with other aspects of the present disclosure, a system for processing domain limited information for cross-platform data migration is provided. The system may comprise an electronic device associated with a user, the electronic device configured to display a graphic user interface associated with a first platform, a central computing system, a secondary computing system, and a network communicatively connecting the electronic device, central computing system, and secondary computing system. The secondary computing system may be configured to receive user input from the electronic device, said user input being received by the electronic device via the graphic user interface and associated with the first platform, transmit data representative of the user input to the central computing system to determine a desired output, select a workflow based at least in part on the desired output, the workflow being associated with one or more required conditions, transmit a gather request for data associated with the one or more required conditions, receive data in response to the gather request, determine whether the one or more required conditions are met, and perform the workflow when the one or more required conditions are met, said workflow being associated with a second platform distinct from the first platform.

In certain embodiments, the system may include an artificial intelligence (AI) system associated with the secondary computing system and the central computing system.

In certain embodiments, the AI system may be a domain-specific large language model.

In certain embodiments, the central computing system and the secondary computing system communicate via API calls.

Unless otherwise defined, all technical and scientific terms used herein have the same meaning as commonly understood by one of ordinary skill in the art to which this invention belongs. The present invention may be embodied in other specific forms without departing from the spirit or essential attributes thereof, and it is therefore desired that the present embodiment be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

Hereinafter, various exemplary embodiments of the disclosure are illustrated in more detail with reference to the drawings.

FIG. 1 illustrates an exemplary embodiment of a partial block diagram of an electronic device, in accordance with aspects of the present disclosure.

FIG. 2 illustrates an exemplary embodiment of a partial block diagram of a computing device, in accordance with aspects of the present disclosure.

FIG. 3 illustrates an exemplary embodiment of a partial block diagram of a server, in accordance with aspects of the present disclosure.

FIG. 4 illustrates an exemplary embodiment of a partial network diagram of a system for processing domain limited information, in accordance with aspects of the present disclosure.

FIG. 5 illustrates an exemplary embodiment of a partial block diagram of logic associated with the system of FIG. 4, in accordance with aspects of the present disclosure.

FIG. 6 illustrates a flowchart providing an exemplary embodiment of a method for processing domain limited information, in accordance with aspects of the present disclosure.

FIG. 7 illustrates an exemplary url wherein certain prompt contents of a model and/or workflow can be adjusted, in accordance with aspects of the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

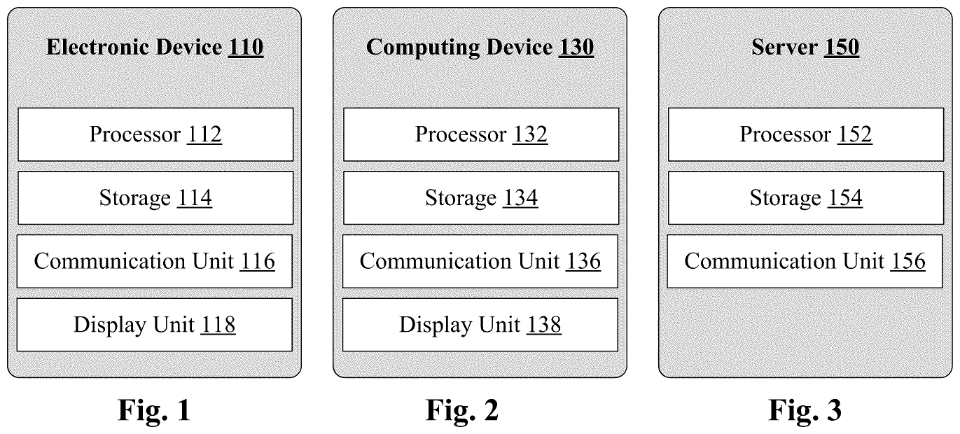

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure. Referring generally to FIGS. 1-7, various exemplary embodiments may now be described of apparatuses, systems, and methods for processing domain limited information, including system 100 as disclosed herein. Where the various figures describe embodiments sharing various common elements and features with other embodiments, similar elements and features are given the same reference numerals and redundant description thereof may be omitted below.

The term “application” may refer to an application executing on a desktop computer or server, or on a mobile device, such as a media player, laptop, smartphone, and/or tablet. The term “application” further refers to an application executing on a web browser on any computing unit, including an electronic device 110, a computing device 130, a server 150, and/or other device of system 100, as further shown in, and described in connection with, FIGS. 1-9.

FIG. 1 illustrates an exemplary embodiment of a partial block diagram of an electronic device 110 of the system 100, in accordance with aspects of the present disclosure. The electronic device 110, which may be associated with a user, such as a user device 110, may include one or more of a processor 112, a storage 114 or a storage medium 114, a communication unit 116, and/or display unit 118. The processor 112 may be a generic hardware processor, a special-purpose hardware processor, or a combination thereof. In embodiments having a generic hardware processor (e.g., as a central processing unit (CPU) available from manufacturers such as Intel and AMD), the generic hardware processor may be configured to be converted to a special-purpose processor by means of being programmed to execute and/or by executing a particular algorithm in the manner discussed herein for providing a specific operation or result. It should be appreciated that the processor 112 may be any type of hardware and/or software processor and is not strictly limited to a microprocessor or any operation(s) only capable of execution by a microprocessor, in whole or in part. The electronic device 110 may include an input/output (I/O) adapter (not shown) that can communicate with an external device(s) (not shown) and/or a user interface adapter (not shown) configured to link to a user input device(s), such as a mouse, keyboard, touch-screen interface, and the like.

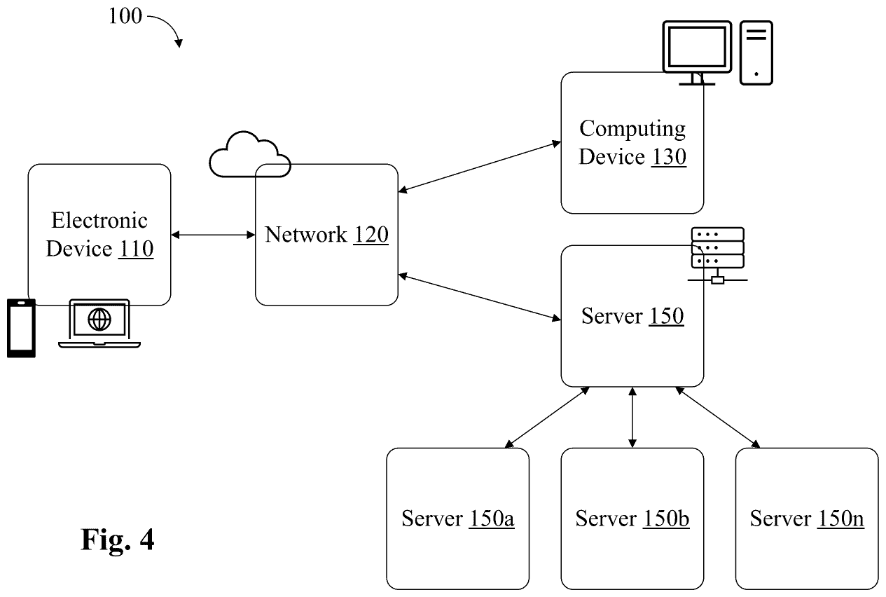

The communication unit 116 of the electronic device 110 may be configured to permit communication—for example via a network 120, as depicted in FIG. 4—which may be performed by wired interface, wireless interface, a combination thereof, or the like. The electronic device 110 may store one or more sets of instructions in a volatile and/or non-volatile storage 114. The one or more sets of instructions may be configured to be executed by the processor 112 to perform at least one operation corresponding to the one or more sets of instructions. The electronic device 110 may include a display unit 118. The display unit 118 may be embodied within the electronic device 110 in one embodiment and/or may be configured to be either wired to or wirelessly interfaced with the electronic device 110. The display unit 118 may be configured to operate, at least in part, based upon one or more operations described herein, as executed by the processor 112 or as otherwise inputted by the external device (not shown) and/or user interface adapter (not shown). The electronic device 110 may be configured to display a graphic user interface (GUI) via the display unit 118. The GUI may be a software platform configured to visually present data to users of the electronic device 110 in a way that is easily understandable to the user. The electronic device 110 may be configured to receive user input. For example, the electronic device 110 may receive user input when a user interacts with the GUI via the user input device(s), such as a mouse, keyboard, touch-screen interface, and the like.

The electronic device 110 may be a standalone device or may be used in combination with at least one external component either locally or remotely communicatively couplable with the electronic device 110—for example via the network 120, as depicted in FIG. 4. The electronic device 110, and specifically the storage 114 of the electronic device 110, may be configured to store, access, or provide at least a portion of information usable to permit one or more operations described herein. The electronic device 110, and more specifically the storage 114 of the electronic device 110, may additionally or alternatively be configured to store content data and/or metadata to enable one or more operations described herein. In optional embodiments, the electronic device 110 may constitute one or more of a desktop computer, a portable computer, such as a laptop, a notebook, or a tablet-type computer, or smart cellular devices, including cellular devices employing an Android-based operating system (OS) or an Apple-based operating system (OS). For example, the electronic device 110 may be configured to present a user with a portal, webpage, interface, and/or downloadable application to enable one or more operations described herein.

FIG. 2 illustrates an exemplary embodiment of a computing device 130 of the system 100, in accordance with aspects of the present disclosure. The computing device 130 may include one or more of a processor 132, a storage 134 or a storage medium 134, a communication unit 136, a display unit 138. At least one computing device 130 may be used to perform one or more operations or functions described herein, either alone or in combination with one or more other computing device 130 and/or other computing element.

The processor 132 may be a generic hardware processor, a special-purpose hardware processor, or a combination thereof. In embodiments having a generic hardware processor (e.g., as a central processing unit (CPU) available from manufacturers such as Intel and AMD), the generic hardware processor may be configured to be converted to a special-purpose processor by means of being programmed to execute and/or by executing a particular algorithm in the manner discussed herein for providing a specific operation or result. It should be appreciated that the processor 132 may be any type of hardware and/or software processor and is not strictly limited to a microprocessor or any operation(s) only capable of execution by a microprocessor, in whole or in part.

The communication unit 136 of the computing device 130 may be configured to permit communication (e.g., via the network 120, as depicted in FIG. 4), which may be performed by wired interface, wireless interface, a combination thereof, or the like. The computing device 130 may store one or more sets of instructions in a volatile and/or non-volatile storage 134. The one or more sets of instructions may be configured to be executed by the processor 132 to perform at least one operation corresponding to the one or more sets of instructions. The processor 132 may retrieve and execute the instructions in logic 140 (further described below) from the storage medium 134 of the computing device 130 to execute various functions of the system 100. Specifically, the storage medium 134 may store logic 140, such as information and instructions for the processor 132 to carry out the operations disclosed herein. Non-limiting examples of the information stored on the storage medium 134 includes information and instructions on how to retrieve information from the memory or storage medium(s), enable the smooth data flow to various components of the system 100, how to manage various information or data used by the system 100, how to control logic 140 for data transfers between various components of the system 100, how to control logic 140 to trigger an information exchange between various components of the system 100, how to process data or information received from other system components (including, but not limited to, the electronic device 110 and the one or more servers 150) via the network 120, and more. In certain embodiments, the processor 132 may also be a processor dedicated to, or otherwise capable of, the training of neural networks and other artificial intelligence systems.

The computing device 130 may include a display unit 138. The display unit 138 may be embodied within the computing device 130 in one embodiment and/or may be configured to be either wired to or wirelessly interfaced with the computing device 130. The display unit 138 may be configured to operate, at least in part, based upon one or more operations of the described herein, as executed by the processor 132.

The computing device 130 may be a standalone device or may be used in combination with at least one external component either locally or remotely communicatively couplable with the computing device 130 (e.g., via the network 120, as depicted in FIG. 4). The computing device 130 may be configured to store, access, or provide at least a portion of information usable to permit one or more operations described herein. For example, the computing device 130 may be configured to provide a portal, webpage, interface, and/or downloadable application to the electronic device 110 to enable one or more operations described herein. The computing device 130 may additionally or alternatively be configured to store content data and/or metadata to enable one or more operations described herein. The one or more interfaces may be accessible to a user of the electronic device 110, for example via communications between the computing device 130 and the electronic device 110 via the network 120. In optional embodiments, the computing device 130 may constitute one or more of a desktop computer, a portable computer, such as a laptop, a notebook, or a tablet-type computer, or smart cellular devices, including cellular devices employing an Android-based operating system (OS) or an Apple-based operating system (OS). The computing device 130 may include an input/output (I/O) adapter (not shown) that can communicate with an external device(s) (not shown) and/or a user interface adapter (not shown) configured to link to a user input device(s), such as a mouse, keyboard, touch-screen interface, and the like.

FIG. 3 illustrates an exemplary embodiment of a partial block diagram of a server 150, in accordance with aspects of the present disclosure. One or more servers 150, including one or more servers 150a, 150b, . . . , 150n, as illustratively conveyed in FIG. 4, may include one or more devices configured to store data, to operate upon data, and/or to perform at least one action described herein. The server 150 may include one or more of a processor 152, a storage 154 or a storage medium 154, and/or a communication unit 156. For the purpose of this disclosure, when referring to the server 150, the server 150 may constitute any one or more of servers 150a, 150b, . . . , or 150n. Like the computing device 130, the one or more servers 150a, 150b, . . . 150n may be configured to provide a portal, webpage, interface, and/or non-downloadable application, to the electronic device 110 for example, to enable one or more operations described herein. Further, like the computing device 130, the server 150 may be used to perform one or more operations or functions described herein, either alone or in combination with one or more other server 150n and/or other computing element.

The processor 152 may be a generic hardware processor, a special-purpose hardware processor, or a combination thereof. In embodiments having a generic hardware processor (e.g., as a central processing unit (CPU) available from manufacturers such as Intel and AMD), the generic hardware processor may be configured to be converted to a special-purpose processor by means of being programmed to execute and/or by executing a particular algorithm in the manner discussed herein for providing a specific operation or result. It should be appreciated that the processor 152 may be any type of hardware and/or software processor and is not strictly limited to a microprocessor or any operation(s) only capable of execution by a microprocessor, in whole or in part.

The communication unit 156 may be configured to permit communication (e.g., via the network 120, as depicted in FIG. 4), which may be performed by wired interface, wireless interface, a combination thereof, or the like. Each server 150 may store one or more sets of instructions in a volatile and/or non-volatile storage 154. The one or more sets of instructions may be configured to be executed by the processor 152 to perform at least one operation corresponding to the one or more sets of instructions.

A plurality of servers 150, such as servers 150a, 150b, . . . , 150n, may be configured in a distributed manner, such as a distributed computing system, cloud computing system, or the like. At least one server 150 may be configured to provide information, metadata, and/or combination thereof in relation to information usable in a manner described herein to process and respond to user input. In addition, or alternatively, one or more servers 150 may be structurally and/or functionally equivalent to the computing device 130. At least one server 150 may be a third-party server configured to provide information to the computing device 130 to permit or enhance at least one operation or function described herein as being performed by or in association with the computing device 130.

The one or more servers 150a, 150b, . . . , 150n may include a database server (not shown). The database server (not shown) may store various types of data and/or instructions for performing at least some of the operations described herein. The database server (not shown) may include a processor (not shown), a storage or a storage medium (not shown), and/or a communication unit (not shown). The database server (not shown) may have other software components, such as a database engine (not shown), allowing for security mechanisms to protect data stored on the storage medium (including authentication, authorization, encryption, and auditing features), backup and recovery mechanisms (not shown), and more.

FIG. 4 illustrates an exemplary embodiment of a partial network diagram of the system 100, in accordance with aspects of the present disclosure. The system 100 includes a simplified partial network block diagram reflecting a functional communicative configuration implementable according to aspects of the present disclosure. While certain components are shown, such as the electronic device 110, computing device 130, and the one or more servers 150a, 150b, . . . , 150n, other embodiments of networks of the system 100 are possible in accordance with the present disclosure. In certain embodiments, the system 100 may include the electronic device 110 couplable to the network 120, the computing device 130 couplable to the network 120, and the one or more servers 150a, 150b, . . . , 150n couplable to the network 120. In one exemplary embodiment, the network 120 may include the Internet, a public network, a private network, and/or any other communications medium capable of conveying electronic communications, either alone or in combination. Connection between one or more computing elements described herein and the network 120 may be configured to be performed by wired interface, wireless interface, a combination thereof, or the like without departing from the spirit and the scope of the present disclosure. In certain embodiments, the system 100 may be configured to communicate with, for example via the network 120, or otherwise interface with an existing system, such as an existing cloud-based voice communication system, such as Zoom, Slack, Skype, Google Meet, WebEx, and Microsoft Teams to name a few examples. Each of these cloud-based voice communication systems may also be referred to herein as a platform. In certain embodiments, various components of the system 100, such as the electronic device 110, computing device 130, and/or the one or more servers 150a, 150b, . . . 150n, may be components of an existing system and may be utilized by the system 100.

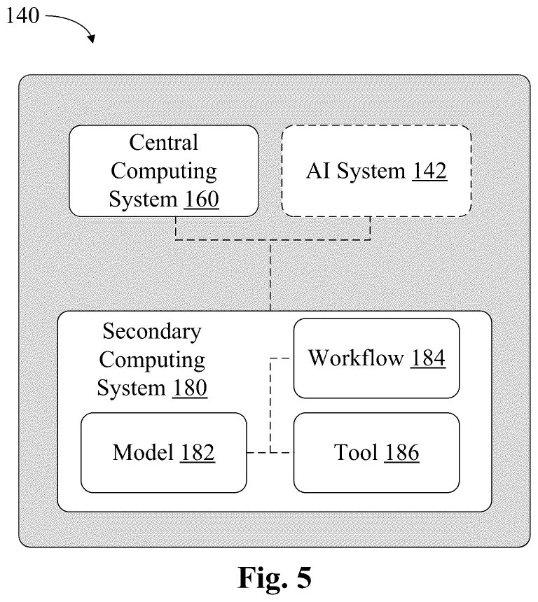

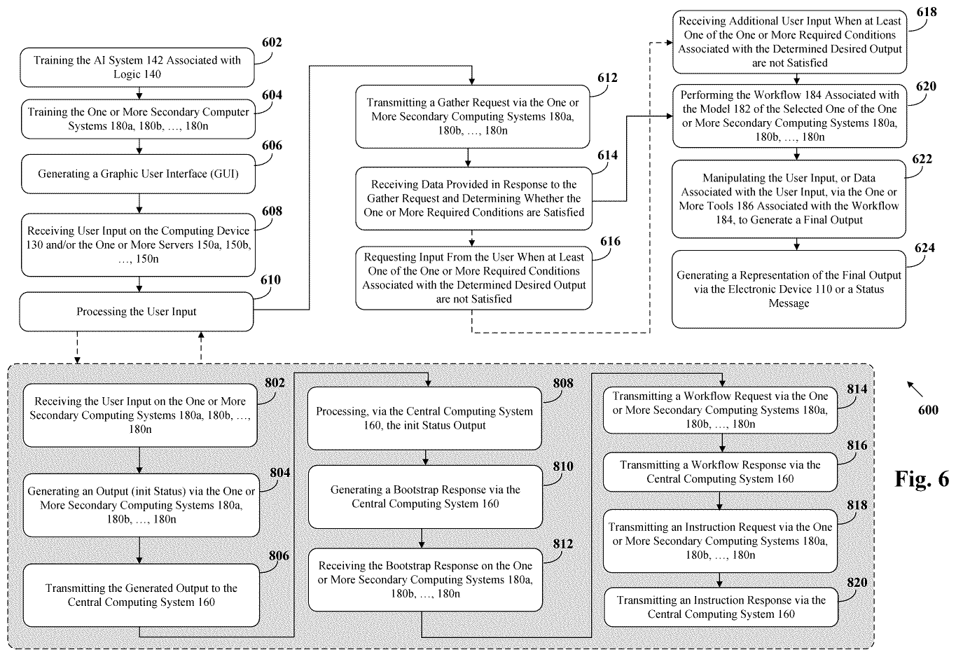

FIG. 5 illustrates an exemplary embodiment of a partial block diagram of logic 140, in accordance with aspects of the present disclosure. In certain embodiments, logic 140 may be fine-tuned using training data such that logic 140 may optimize response generation for an intended domain. Logic 140 may include hardware, firmware, software, and/or combinations of each to perform one or more functions or actions. In certain exemplary embodiments, based on a desired application or need, logic 140 may include a software-controlled processor, discrete logic such as an application specific integrated circuit (ASIC), programmed logic device, or other processor. In other exemplary embodiments, logic 140 may also be fully embodied in software. As used herein, “software” may include, but is not limited to, one or more computer readable and/or executable instructions that cause a processor or other electronic device to perform functions, actions, processes, and/or behave in a desired manner. The instructions may be embodied in various forms such as routines, algorithms, modules, or programs including separate applications or code from dynamically linked libraries (DLLs). In certain exemplary embodiments, software may be implemented in various forms such as a stand-alone program, a web-based program, a function call, a subroutine, a servlet, an application, an applet, a plug-in, instructions stored in a memory, part of an operating system, or other type of executable instructions or interpreted instructions from which executable instructions are created.

In certain embodiments, logic 140 may reside on, or otherwise be associated with, the computing device 130, the one or more servers 150a, 150b, . . . , 150n, or other device associated with the network 120 and/or the system 100. In other embodiments, logic 140 may reside on, or otherwise be associated with, multiple devices associated with the network 120 and/or the system 100. For example, in certain optional embodiments, a central computing system 160 (described below) of logic 140 may reside on a first device, such as the one or more servers 150a, 150b, . . . , 150n, and one or more secondary computing systems 180a, 180b, 180n (described below) of logic 140 may reside on a second device, such as the computing device 130.

Logic 140 may include, or otherwise be associated with, an artificial intelligence (AI) system 142. The AI system 142 may enable analysis of large structured or unstructured and changing data sets, deductive or inductive reasoning, complex problem solving, and computer learning based on, for example, historical patterns, expert input, and/or feedback loops, among other functionalities. “AI,” as used herein, may refer to and/or include a wide field of tools and techniques in the field of computer science. In certain exemplary embodiments, these tools may include symbolic artificial intelligence, machine learning, and evolutionary algorithms. Large Language Models (LLMs) and artificial neural networks, for example, may be used in a variety of machine learning applications and may employ various learning methods including, but not limited to, statistical learning, deep learning, supervised learning, unsupervised learning, and reinforcement learning. The AI system 142 may enable logic 140 to adapt to situations not anticipated or predicted by programmers of logic 140 and may facilitate sophisticated ways of interacting with user input to achieve a desirable outcome. While particular AI tools may be described herein, other artificial intelligence tools may be used for the same task so that the description of one tool or technique should not be viewed as limiting the application to only that tool or technique unless otherwise stated herein.

As used herein, “large language model,” or “LLM,” may refer to a model that processes natural language content and/or other input, and/or generates output reflecting generative content that is responsive to the natural language content and/or other input. The LLM may be a zero-shot model, a fine-tuned or domain-specific model, a language representation model, or a multimodal model, to name a few examples. The LLM may be trained on a large volume of data through multiple steps, including an unsupervised learning step wherein the LLM is trained on unstructured and/or unlabeled data, a self-supervised learning step wherein the LLM is trained on labeled data, a deep learning step wherein the LLM goes through a neural network process, such as a transformation process, and/or a reinforcement learning step wherein outputs are graded to improve accuracy. The neural network transformation process may enable the LLM to recognize relationships and/or connections between natural language and other inputs through assigning weights to portions of the natural language.

As used herein, “neural network” may refer to a plurality of interconnected software nodes or neurons that are arranged into a plurality of layers, such as, for example, input layers, hidden layers, and output layers. Each node may have one or more input connections and output connections to create a many-to-many relationship with other nodes in the network. Accordingly, the output of a single node may be connected to the input of many different nodes and a single node can receive as input the output of many different nodes. Each node of the network may be configured to perform calculations on the data from other nodes and to calculate output data in conjunction with node parameters that are adjusted during the training process from the neural network. Thus, each node of the network may be a computational unit that has one or more input connections for receiving input data from nodes in a previous layer of the network and one or more output connections for transmitting output data to nodes in a subsequent or next layer in the network. Each node may include a calculation unit for calculating the result of an activation function that can incorporate the input data received via the input connections, input parameters associated with each input connection, and an optional function parameter to compute output data that can be further modified by an output parameter. The result of the activation function may be transmitted as output data via the output connection to nodes in subsequent layers of the neural network.

During training of the AI system 142, parameters for each node in the neural network may be adjusted until the output of the neural network corresponds to a desired output for a set of input data. The trained neural network may be characterized by the collection of node parameters that have been adjusted during the training process. The neural network may also be trained continuously such that the node parameters are updated periodically based on feedback provided from data sources.

In certain exemplary embodiments, the AI system 142 may be a small and/or lightweight domain-specialized model. The AI system 142 may be tuned in a closed loop whereby execution traces and validation outcomes are recycled into the training corpus to iteratively refine the accuracy and/or reliability of the AI system 142. The AI system 142 may collect certain operational artifacts including prompts from APIs, extracted tool calls, instruction sets, execution logs, and validation outcomes, to name a few examples. Once migrations (discussed in detail below) via the system 100 have been completed and/or terminated (upon failure to complete), the AI system 142 may annotate and/or label the migrations as successful or failed, based on validation results, errors, operator overrides, or the like, and train on the data associated therewith. This operational feedback continually increases the overall reliability of the AI system 142, and the system 100 as a whole, without requiring large retraining events.

One exemplary advantage of the AI system 142 disclosed herein may be that the generally small size of the AI system 142 provides for low latency, low cost, and/or on-premise deployability. Thus, the AI system 142 allows for greater flexibility and can be configured to meet the specific needs of users/customers.

In certain embodiments, logic 140 may include a central computing system 160 (also referred to herein as a logic application 160) and a secondary computing system 180 (also referred to herein as a brain 180). In certain embodiments, the secondary computing system 180 may include one or more secondary computing systems 180a, 180b, . . . , 180n. In certain embodiments, the central computing system 160 may be communicatively coupled, or otherwise connected, to the secondary computing system 180 via one or more channel (not shown). In certain embodiments where the secondary computer system includes one or more secondary computing systems 180a, 180b, . . . 180n, the one or more secondary computing system 180a, 180b, . . . 180n may be interconnected via the one or more channels (not shown). In certain embodiments, the central computing system 160 may be configured to store prompts and/or training data associated with the AI system, and in certain instances an LLM. Further, the AI system may reside on, or otherwise be associated with, the central computing system 160 in certain optional embodiments.

The central computing system 160 of logic 140 may be configured, for example, to receive and process data, and further to make decisions based on said data. In certain exemplary embodiments, the central computing system 160 may include, or otherwise be associated with, the AI system 142, and may ingest/process data, such as user input or a representation of user input, at least partially via the AI system 142. The central computing system 160 may be configured to communicate with the secondary computing system, for example via the one or more channels (not shown), at least in part in response to the user input. Communications between the central computing system 160 and the secondary computing system 180, or between a plurality of the secondary computing systems 180, may be via application programming interface (API) calls.

The secondary computing system 180 may comprise a model 182. Each model 182 may also be referred to herein as a bot 182. In certain embodiments where the secondary computer system includes one or more secondary computing systems 180a, 180b, . . . , 180n, each of the one or more secondary computing systems 180a, 180b, . . . , 180n may comprise a different model 182, or certain ones of the one or more secondary computing systems 180a, 180b, . . . , 180n may have the same or similar models 182. Each model 182 may be associated with a workflow 184 comprising one or more steps configured to complete a domain specific task. In certain optional embodiments, each model 182 may comprise a plurality of workflows 184. Each of the plurality of workflows 184 may be configured for or associated with the migration of data between heterogenous platforms, such as Zoom, Slack, Skype, Google Meet, WebEx, and/or Microsoft Teams to name a few examples. The plurality of workflows 184 may be configured such that they may be performed on a variety of platforms, such that the plurality of workflows 184 are agnostic of platform. Each step of the workflow 184 may be associated with or reference one or more tools 186, otherwise referred to as predefined operations. In certain embodiments, the one or more tools 186 may refer to a code representation of a task or action, like an API call or a javascript command. For example, in certain embodiments, one of the one or more tools 186 associated with the workflow 184 may be an API call, such as a GET API call, a POST API call, a PUT API call, a DELETE API call, and a BATCH API call to name a few examples. Each of the one or more secondary computing systems 180a, 180b, . . . 180n may be communicatively coupled to the central computing system 160 and/or to other devices of the system 100, for example, via the channels discussed above.

Each model 182 of the one or more secondary computing systems 180a, 180b, . . . , 180n may be associated with a topic, a prompt, and/or training data. In certain optional embodiments of the model 182, such as an embodiment of the model 182 having a plurality of workflows 184, the model 182 may be associated with a plurality of topics, a plurality of prompts, and/or training data. In certain optional embodiments, user input, or a representation thereof, may be routed or directed to a particular secondary computing system 180 based at least in part on the topic and/or prompt associated with the model 182 of the secondary computing system 180. In certain embodiments, each topic may further be associated with a prompt, such as an initial prompt, that may include training data. The training data, for example, may be created when supplemental data is added to a prompt to steer the results thereof. In certain embodiments, each topic may contain a definition referred to herein as a workflow description. The workflow description may be used by the AI system 142, such as the LLM, to determine an appropriate workflow 184 and/or model 182. In certain embodiments, each topic may be defined as an interrupt topic and/or an init topic to name a few examples. An interrupt topic may refer to a topic and/or workflow 184 that can step out of a normal conversation and be treated as a sidebar to a user request. An init topic may refer to a topic that is utilized during an init process (defined below).

FIG. 6 illustrates a flowchart providing an exemplary embodiment of a method 600 of processing domain limited information for cross-platform data migration, in accordance with aspects of the present disclosure. In certain embodiments, the method 600 may be performed using the system 100 discussed above in association with an existing system.

In certain embodiments, the method 600 may commence with an operation 602 of training the AI system 142 associated with logic 140. In certain embodiments, the AI system 142 may form a portion of, or otherwise be associated with, the central computing system 160 of logic 140. The AI system 142 may be trained on a large volume of data through multiple steps, including an unsupervised learning step wherein the LLM may be trained on unstructured and/or unlabeled domain specific data, a self-supervised learning step wherein the LLM may be trained on labeled domain specific data, a deep learning step wherein the LLM may undergo a neural network transformation process, and/or a reinforcement learning step wherein outputs may be graded to improve accuracy. As previously discussed, the AI system 142 may train on data related to prompts from APIs, extracted tool calls, instruction sets, execution logs, and validation outcomes. The AI system 142 may be considered “trained” when the decisions made and/or outputs generated by the AI system 142 reach a threshold level of accuracy. In certain embodiments, operation 602 of training the AI system 142 may continue throughout all or portions of the method 600 such that the AI system 142 is constantly being trained. The AI system 142 in certain embodiments may comprise a small and/or lightweight domain-specific LLM trained in connection with, and with an aim toward, an existing system, such as a cloud-based voice communication systems, such as Zoom, Slack, Skype, Google Meet, WebEx, and Microsoft Teams to name a few examples.

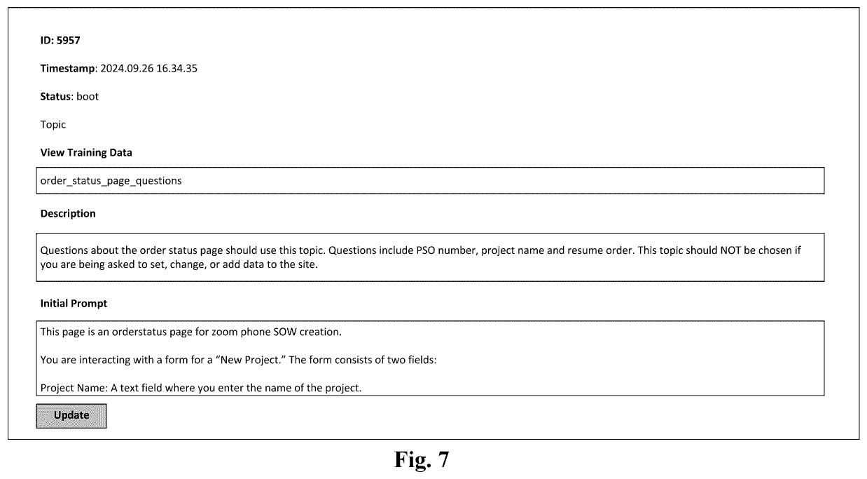

The method 600 may continue with an operation 604 of training each of the secondary computing systems 180a, 180b, . . . , 180n. Each interaction involving the one or more secondary computing systems 180a, 180b, 180n may be accessed via a url that may list the model 182 and/or workflow 184 associated therewith. Those responsible for configuration of the system 100 and/or logic 140, such as engineers to name an example, may steer the specific outcome of a workflow 184 by adjusting certain prompt contents associated with the model 182 and/or workflow 184. For example, FIG. 7 shows an exemplary url wherein certain prompt contents of a model 182 and/or workflow may be adjusted. The Topic reads:
order_status_page_questions

The Description reads:
questions about the order status page should use this topic. Questions include PSO number. project name and resume order. This topic should NOT be chosen if you are being asked to set, change, or add data to the site.

The Initial Prompt reads in part:
This page is an orderstatus page for zoom phone SOW creation.
You are interacting with a form for a “New Project.” The form consists of two fields:
Project Name: A text filed where you enter the name of the project.

The operation 604 of training each of secondary computing systems 180a, 180b, . . . , 180n may directly alter or otherwise affect data, such as the training data, associated with the specified model 182 and/or workflow 184.

The method 600 may continue with an operation 606 of generating a GUI. The GUI may be generated by logic 140, computing system 130, and/or the one or more servers 150a, 150b, . . . , 150n. In certain embodiments, logic 140 may leverage the AI system 142 to generate the GUI or certain portions thereof. The GUI may be displayed on display unit 118 of the electronic device 110 such that a user may interact with the GUI, and thus provide user input, via the user input device(s), such as a mouse, keyboard, touch-screen interface, and the like. In certain embodiments, the GUI may be associated with the system 100 and independent of the existing system. In other optional embodiments, the GUI may be associated with a first platform, and thus a user may simply view the GUI of an existing cloud-based voice communication systems, such as the GUI of Zoom, Slack, Skype, Google Meet, WebEx, or Microsoft Teams. Thus, the user may view interactions with the GUI as interactions with the first platform.

The method 600 may continue with an operation 608 of receiving user input on the computing device 130 and/or the one or more servers 150a, 150b, . . . , 150n. A user may interact with the electronic device 110, and more specifically with the GUI displayed on display unit 118, via the user input device(s), such as a mouse, keyboard, touch-screen interface, and the like. The user input may first be received by the electronic device 110 and the user input, or a signal representing the user input, may then be transmitted by, for example, the communication unit 116 of the electronic device 110 via the network 120 such that the user input, or signal representing the user input, is received on the computing device 130 and/or the one or more servers 150a, 150b, . . . , 150n. The user input may be associated with a request for an action to be taken. The request for action may be associated with or involve the migration of data from the first platform to a second and distinct platform, or vice versa. For example, the request for action may be made by a user using the first platform, but may require data to be transmitted and manipulated by a second system. While the user input may involve the cross-platform migration to data, the user may not be aware that migration is required and thus may enjoy a seamless interaction with the computing device 130.

The method 600 may continue with an operation 610 of processing the user input. Operation 610 of processing the user input may be accomplished via the computing device 130 and/or the one or more servers 150a, 150b, . . . , 150n. In certain embodiments, operation 610 of processing the user input may be accomplished via logic 140 associated with the computing device 130. Operation 610 of processing the user input may include one or more associated operations referred to herein as sub-operations. Certain sub-operations associated with operation 610 are shown in FIG. 8. While these operations may be described herein as sub-operations, it is within the scope of the present disclosure for these operations to be performed separately from operation 610.

Operation 610 of processing the user input may include a sub-operation 802 of receiving the user input on the one or more secondary computing systems 180a, 180b, . . . , 180n. The user input may be transmitted by electronic device 110 via the network 120 to the computing device 130 and/or the one or more servers 150a, 150b, . . . , 150n. Sub-operation 802 may include identifying one or more required conditions associated with a determined desired output associated with the user input. The determined desired output may be a configuration action or the like that is domain specific and may include the migration of data from the first platform to the second platform, or vice versa. The determined desired output may be received via the computing device 130 and/or the one or more servers 150a, 150b, . . . , 150n, whether by user-initiated designation on the electronic device 110 via the GUI accessible in conjunction with the display unit 118, or by automated or other non-user-based initiation, such as through the computing device 130 and/or the one or more servers 150a, 150b, . . . , 150n.

Operation 610 of processing the user input may include a sub-operation 804 of generating an output via the one or more secondary computing systems 180a, 180b, . . . , 180n. In certain optional embodiments, the generated output may be an “init” status and may contain raw data formatted in JSON. One exemplary JSON output reads as follows:

{‘command’: ‘question’, ‘topic’: ‘friendly_conversation’, ‘data’:
{‘answer’: “Hello there! How can I assist you today with your Zoom
Statement of Work or any questions about our Zoom phones and contact
center systems? Or maybe you're just here for a friendly chat?”}}

Operation 610 of processing the user input may include a sub-operation 806 of transmitting said generated output to the central computing system 160. In certain optional embodiments, the generated output may be transmitted to the central computing system 160 via an API call. The generated output may be referred to herein as an init status output.

Operation 610 of processing the user input may include a sub-operation 808 of processing, via the central computing system 160, the init status output. Sub-operation 808 of processing the init status output may include determining a desired output based on the init status output from the one or more secondary computing systems 180a, 180b, . . . 180n which, in certain embodiments, includes the user input. In certain embodiments, the central computing system 160 associated with logic 140 may leverage the AI system 142 to determine the desired output represented by the user input. The desired output may correspond to a desired configuration task or function within the existing system or may require cross-platform data migration. For example, the desired output represented by the user input may be to associate a profile picture with a user profile. The central computing system 160 of logic 140 may use an LLM associated with the AI system 142 to determine the desired output based on natural language contained in the user input. To determine the desired output, the AI system 142 may parse the user input into structure parameters for processing. The AI system 142 may reference data stored on the storage 114 of electronic device 110, storage 136 of the computing device 130, and/or data stored on the storage 156 of the one or more servers 150a, 150b, . . . , 150n, when determining the desired output.

In certain embodiments, the AI model 142 may be periodically fine-tuned as the volume of data being processed by the system 100 increases. Thus, one exemplary advantage of the present disclosure may be that the extraction precisions associated with the AI model 142 improves over time and as the volume of data grows.

Operation 610 of processing the user input may include a sub-operation 810 of generating a response, via the central computing system 160, to the generated output transmitted from the one or more secondary computing systems 180a, 180b, . . . , 180n, and transmitting the generated response back to the one or more secondary computing systems 180a, 180b, . . . , 180n. The generated response may be referred to herein as a bootstrap response. The bootstrap response may include raw data and/or a selected topic associated with a specific model 182 and/or workflow 184. The topic may be selected based on the workflow description associated with the model 182 and/or workflow 184. The central computing system 160 may match the init status output transmitted from the one or more secondary computing systems 180a, 180b, . . . , 180n, which may include a desired output, to the topic and/or workflow description associated with the model 182 and/or workflow 184.

Operation 610 of processing the user input may include a sub-operation 812 of receiving, on the one or more secondary computing systems 180a, 180b, . . . , 180n, the bootstrap response generated by the central computing system 160.

Operation 610 of processing the user input may include a sub-operation 814 of transmitting, via the one or more secondary computing systems 180a, 180b, . . . , 180n, a workflow request back to the central computing system 160 based at least in part on the bootstrap response. In certain optional embodiments, the workflow request may be transmitted to the central computing system 160 via an API call. The workflow request may be a request for relevant details associated with a workflow 184, such as a topic, prompt, and/or training data.

Operation 610 of processing the user input may include a sub-operation 816 of transmitting, via the central computing system 160, a workflow response back to the one or more secondary computing systems 180a, 180b, . . . , 180n based at least in part on the workflow request. The workflow response may include relevant details associated with a workflow 184, such as a topic, prompt, and/or training data. The workflow 184 may be configured to achieve the desired output.

Operation 610 of processing the user input may include a sub-operation 818 of transmitting, via the one or more secondary computing systems 180a, 180b, . . . , 180n, an instruction request back to the central computing system 160 based at least in part on the workflow response. In certain optional embodiments, the instruction request may be transmitted to the central computing system 160 via an API call. The instruction request may be a request for instructions associated with, or configured to carry out, the workflow 184. In certain optional embodiments, the instruction request may contain raw data formatted in JSON.

Operation 610 of processing the user input may include a sub-operation 820 of transmitting, via the central computing system 160, an instruction response back to the one or more secondary computing systems 180a, 180b, . . . , 180n based at least in part on the instruction request. The instruction response may include one or more steps associated with carrying out the workflow 184, and may further include certain data and/or details regarding one or more tools 186 associated with the workflow 184 or the steps thereof. The one or more tools 186 may refer to a code representation of a task or action, like an API call or a javascript command. The instruction response may represent one or more required conditions associated with the determined desired output, for example, one or more required conditions that must be satisfied to achieve the determined desired output. In certain embodiments, identifying one or more required conditions associated with the determined desired output may be accomplished via the one or more secondary computing systems 180a, 180b, . . . , 180n of logic 140. In certain embodiments, the one or more secondary computing systems 180a, 180b, . . . , 180n may leverage the AI system 142 to identify the one or more required conditions. Logic 140 may use the AI system 142 including, in certain embodiments, an LLM. The AI system 142 may reference data stored on the storage 114 of electronic device 110, storage 136 of the computing device 130, and/or data stored on the storage 156 of the one or more servers 150a, 150b, . . . , 150n, when identifying the one or more required conditions associated with the determined desired output. The instruction response may abstract away differences between the first platform with which the user is associated with and the second platform such that data migration may be seamless. Thus, the instruction response may include one or more steps that carry out a workflow 184 based on the data provided by the user but agnostic of the platform being used.

The method 600 may continue with an operation 612 of transmitting, via the one or more secondary computing systems 180a, 180b, . . . , 180n, a gather request based at least in part on the instruction response. In certain optional embodiments, the gather request may be transmitted by the one or more secondary computing systems 180a, 180b, . . . , 180n via an API call. The gather request may be a request for data associated with the one or more required conditions associated with the determined desired output.

The method may continue with an operation 614 of receiving data provided in response to the gather request on the one or more secondary computing systems 180a, 180b, . . . , 180n, and further determining whether the one or more required conditions associated with the determined desired output are satisfied. In certain embodiments, operation 614 may be accomplished via logic 140, and more specifically via the one or more secondary computing systems 180a, 180b, . . . , 180n of logic 140. In certain embodiments, the one or more secondary computing systems 180a, 180b, . . . , 180n associated with logic 140 may leverage the AI system 142 to determine whether the one or more required conditions associated with the determined desired output are satisfied. If the one or more required conditions associated with the determined desired output are satisfied, the method 600 may proceed to operation 620 and a completed status may be marked. In certain scenarios, the user input received by the one or more secondary computing systems 180a, 180b, . . . , 180n in operation 608 may provide all data needed to meet the one or more required conditions. However, in certain scenarios, additional data may be needed to meet the one or more required conditions and thus additional user input may be needed. If at least one of the one or more required conditions associated with the determined desired output are not satisfied, the method 600 may proceed to operation 616.

The method 600 may continue with an operation 616 of requesting input from the user when at least one of the one or more required conditions associated with the determined desired output are not satisfied. The computing device 130 and/or the one or more servers 150a, 150b, . . . , 150n may generate a request representing the at least one identified one or more required conditions that is unmet and may further transmit the request to the electronic device 110 via the network 120. In certain embodiments, the one or more secondary computing systems 180a, 180b, . . . , 180n of logic 140, in association with the AI system 142, may generate the request representing the at least one identified one or more required conditions that is unmet. The electronic device 110 may receive the request and further display a visual representation of the request via the GUI accessible in conjunction with the display unit 118.

The method 600 may continue with an operation 618 of receiving additional user input when at least one of the one or more required conditions associated with the determined desired output are not satisfied. The received additional input may be responsive to the request generated by the computing device 130 and/or the one or more servers 150a, 150b, . . . , 150n in operation 616, and may represent at least one of the one or more required conditions associated with the determined desired output that is not satisfied. The additional input from the user may be received on the computing device 130 and/or the one or more servers 150a, 150b, . . . , 150n, and may further be received by the one or more secondary computing systems 180a, 180b, . . . , 180n of logic 140.

Operation 614 of determining whether the one or more required conditions associated with the determined desired output are satisfied may then be repeated. In certain embodiments, if the one or more required conditions associated with the determined desired output are satisfied, the method 600 may proceed to operation 620 and a completed status may be marked. In certain embodiments, if at least one of the one or more required conditions associated with the determined desired output are not satisfied, the method 600 may then repeat operations 616 and 618. In other words, if at least one of the one or more required conditions associated with the determined desired output are not satisfied, the computing device 130 and/or the one or more servers 150a, 150b, . . . 150n, and more specifically the one or more secondary computing systems 180a, 180b, . . . , 180n of logic 140, may generate requests representing the at least one identified one or more required conditions that is unmet, and further receive additional user input. This iterative process may continue until the one or more required conditions associated with the determined desired output are satisfied.

The method 600 may continue with an operation 620 of performing the workflow 184 associated with the model 182 of the selected one of the one or more secondary computing systems 180a, 180b, 180n. In certain embodiments, operation 620 of performing the workflow 184 may include migrating data from the first platform to the second platform. The operation 620 of carrying out the workflow 184 may include an associated operation or sub-operation 622 of manipulating the user input, or data associated with the user input, via the one or more tools 186 associated with the workflow 184, to generate a final output. The data may be manipulated such that any specificity as to platform is removed and the data associated with the user input may be seamlessly manipulated by any of the first and/or second platform and migrated between said platforms to perform the workflow 184 and achieve the desired output.

The method 600 may continue with an operation 624 of generating a representation of the final output. The operation 624 may include generating a status message associated with a status of the final output as it relates to the desired output associated with the user input. The representation of the final output and/or the status message may be displayed on display unit 118 of the electronic device 110 as part of the GUI. Thus, operation 630 may enable a user to view and/or interact with the accepted output signal via the GUI. For example, in certain optional embodiments, the representation of the accepted output signal may be displayed on display unit 118 of the electronic device 110 as party of the GUI associated with the existing system, such as the GUI of Zoom, Slack, Skype, Google Meet, WebEx, or Microsoft Teams.

The method 600 may begin again with operation 602 of training the AI system 142 associated with logic 140. The final output, the status message, or any other data related to the method 600 may be fed back into the Ai system 142 to train the model. Thus, the AI system 142 may train in a “closed environment.”

In certain embodiments, the user input may be generated in a GUI associated with a first platform, such as Zoom, Slack, Skype, Google Meet, WebEx, or Microsoft Teams. The workflow 184 may be carried out in association with a second platform that is different from the first platform. However, the user may not be able to detect or may not be notified that the user input, or data associated therewith, is migrated cross-platform to complete the tasks, thus providing a seamless experience to the user.

In certain embodiments of the system 100 and/or the method 600, user input, whether through the GUI or through another interface, may be interpreted as high-level requests. The user input may be mapped to a corresponding tool or other predefined operation, such as an API call, that performs a desired configuration task or function within a predefined cloud-based voice communication system, such as Zoom, Slack, Skype, Google Meet, WebEx, and Microsoft Teams to name a few examples. Thus, one exemplary advantage of the system 100 and/or the method 600 may be that the system 100 and/or method 600 standardizes and simplifies interactions, providing consistency between API-based and GUI-based configurations. Further, the system 100 and/or method 600 may provide a unified way to handle configuration, regardless of whether the user prefers a graphical interface or direct API integration.

In certain embodiments of the system 100 and/or the method 600, communications via the channels may be fluid and may be completed if the proper GUID for that conversation is applied.

One exemplary advantage associated with the method 600 disclosed herein may be that the “init” status outputs, bootstrap responses, workflow requests, workflow responses, instruction requests, and instruction responses enforce, or at least encourage, correctness and reduce hallucinations.

The term “user” as used herein unless otherwise stated may refer to any person or entity as may be, e.g., associated with the electronic device 110 or the computing device 130 for providing input as disclosed herein.

It is understood that various operations, steps, or algorithms, including the method 500, as described in connection with the electronic device 110, the computing device 130, and the one or more servers 150, or alternative devices, can be embodied directly in hardware, in a computer program product such as a software module executed by the processor 112, the processor 132, and/or the processor 152, or in a combination of the foregoing. The computer program product can reside in RAM memory, flash memory, ROM memory, EPROM memory, EEPROM memory, registers, hard disk, a removable disk, or any other form of computer-readable medium known in the art.

Terms such as “a,” “an,” and “the” are not intended to refer to only a singular entity, but rather include the general class of which a specific example may be used for illustration.

The phrases “in one embodiment,” “in optional embodiment(s),” and “in an exemplary embodiment,” or variations thereof, as used herein does not necessarily refer to the same embodiment, although it may.

As used herein, the phrases “one or more,” “at least one,” and “one or more of,” or variations thereof, when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. The conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Thus, such conditional language is not generally intended to imply that features, elements, and/or states are in any way required for one or more embodiments, whether these features, elements, and/or states are included or are to be performed in any particular embodiment.

The previous detailed description has been provided for the purposes of illustration and description. Thus, although there have been described particular embodiments of new and useful APPARATUSES, SYSTEMS, AND METHODS OF PROCESSING DOMAIN LIMITED INFORMATION FOR CROSS-PLATFORM DATA MIGRATION, it is not intended that such references be construed as limitations upon the scope of this disclosure except as set forth in the following claims. Thus, it is seen that the apparatus of the present disclosure readily achieves the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims.

What is claimed is:

1. A method for processing domain limited information for cross-platform data migration, comprising:
receiving user input on a secondary computing system, said user input being associated with a first platform;
processing the user input via the secondary computing system and a central computing system, wherein processing the user input includes:
transmitting data representative of the user input via the secondary computing system to the central computing system to determine a desired output;
selecting a workflow based at least in part on the desired output, the workflow being associated with one or more required conditions;
transmitting a gather request for data associated with the one or more required conditions via the secondary computing system;
receiving data via the secondary computing system in response to the gather request;
determining whether the one or more required conditions are met; and
performing the workflow when the one or more required conditions are met, said workflow associated with a second platform distinct from the first platform.

2. The method of claim 1, wherein processing the user input via the secondary computing system and central computing system includes processing the user input via an artificial intelligence (AI) system associated with the secondary computing system and the central computing system.

3. The method of claim 2, wherein the AI system is a domain-specific large language model.

4. The method of claim 3, wherein the AI system is continuously trained such that the accuracy of the AI system improves.

5. The method of claim 1, further comprising:
generating a graphic user interface for display on an electronic device;
wherein the electronic device is configured to receive the user input through the GUI.

6. The method of claim 5, wherein the graphic user interface corresponds to the first platform.

7. The method of claim 1, wherein transmitting data representative of the user input via the secondary computing system to the central computing system to determine a desired output includes identifying the one or more required conditions.

8. The method of claim 1, wherein transmitting data representative of the user input via the secondary computing system to the central computing system to determine a desired output includes determining the desired output via an AI system.

9. The method of claim 8, wherein determining the desired output via an AI system includes parsing the user input into structured parameters.

10. The method of claim 1, wherein processing the user input via the secondary computing system and a central computing system includes receiving one or more steps associated with the workflow via the secondary computing system.

11. The method of claim 1, further comprising:
transmitting an additional data request to an electronic device associated with a user when at least one of the one or more required conditions are not met.

12. The method of claim 11, further comprising:
receiving additional user input via the secondary computing system in response to the additional data request.

13. The method of claim 1, wherein performing the workflow when the one or more required conditions are met includes migrating data from the first platform to the second platform.

14. The method of claim 1, further comprising:
generating a representation of a final output on an electronic device associated with a user.

15. The method of claim 1, further comprising:
generating a status message associated with a final output on an electronic device associated with a user.

16. The method of claim 1, wherein the central computing system and the secondary computing system communicate via API calls.

17. A system for processing domain limited information for cross-platform data migration, comprising:
an electronic device associated with a user, the electronic device configured to display a graphic user interface associated with a first platform;
a central computing system;
a secondary computing system;
a network communicatively connecting the electronic device, central computing system, and secondary computing system;
wherein said secondary computing system is configured to:
receive user input from the electronic device, said user input being received by the electronic device via the graphic user interface and associated with the first platform;
transmit data representative of the user input to the central computing system to determine a desired output;
select a workflow based at least in part on the desired output, the workflow being associated with one or more required conditions;
transmit a gather request for data associated with the one or more required conditions;
receive data in response to the gather request;
determine whether the one or more required conditions are met; and
perform the workflow when the one or more required conditions are met, said workflow being associated with a second platform distinct from the first platform.

18. The system of claim 17, further comprising:
an artificial intelligence (AI) system associated with the secondary computing system and the central computing system.

19. The system of claim 18, wherein the AI system is a domain-specific large language model.

20. The system of claim 17, wherein the central computing system and the secondary computing system communicate via API calls.
